(19) United States
(12) Patent Application Publication
(10) Pub. No.: US 2015/0250000 A1
(43) Pub. Date: Sep. 3, 2015

(54) REDUCING INTER-SS INTERFERENCE

(71) Applicant: Telsima Corporation, Santa Clara, CA (US)

(72) Inventor: Nurettin Burcak Beser, Palo Alto, CA (US)

(73) Assignee: TELSIMA CORPORATION, Santa Clara, CA (US)

(21) Appl. No.: 14/711,681

(22) Filed: May 13, 2015

Related U.S. Application Data
(63) Continuation of application No. 12/360,801, filed on Jan. 27, 2009.
Application No. 12/360,801 is a continuation of application No. 11/737,743, filed on Apr. 19, 2007, now abandoned.
(60) Provisional application No. 60/745,174, filed on Apr. 19, 2006.

(51) Int. Cl. H04W 72/12; H04W 72/08; H04W 72/04; H04W 4/02

(52) U.S. Cl. CPC H04W 72/1226; H04W 4/02; H04W 72/121; H04W 72/082; H04W 72/0446

(57) ABSTRACT

Certain embodiments are described that enable the provision of enhanced service in wireless networks. Methods for wireless broadband scheduling are described that comprise determining levels of potential interference between subscriber stations located in an area covered by a wireless base station. Communication between the wireless base station and the subscriber stations can be scheduled to minimize interference between the subscriber stations. Scheduling may include ordering the subscriber stations based on the determined levels of potential interference for each station. Such scheduling may result in a list organized in ascending or descending order of potential interference or distance from the base station. Certain of the subscriber stations can be selected to communicate simultaneously based on the ordering. In certain of these embodiments, the ordering can be calculated to reduce mutual interference of the subscriber stations. Determining levels of potential interference can include measuring interference on each subscriber station.

### CROSS-REFERENCE TO RELATED APPLICATIONS

The present application is a continuation of U.S. patent application Ser. No. 12/360,801, filed Jan. 27, 2009 and entitled “Reducing Inter-SS Interference,” which is a continuation of U.S. patent application Ser. No. 11/737,743, filed Apr. 19, 2007 and entitled “Reducing Inter-SS Interference,” now abandoned, which claims priority to U.S. Provisional Patent Application Ser. No. 60/745,174, filed Apr. 19, 2006 and entitled “Reducing Inter-SS Interference,” the disclosures of which are incorporated by reference herein.

### BACKGROUND OF THE INVENTION

1. Field of the Invention

The application relates to communications systems and more particularly to wireless communications networks.

2. Description of Related Art

In current wireless networks, almost all multiple-cell, multiple-sector systems use well known frequency division duplex (“FDD”) mechanisms to run multiple radios in a physical location. The use of FDD helps to reduce the interference of the radio transmitters. Wireless Broadband Access (“WBA”) based systems have been designed to have operational characteristics that are indistinguishable from Cable or DSL methods of broadband access from the viewpoint of the customer. However, wireless systems are subject to substantial signal fading and interference.

Today almost all of the multiple-cell/multiple-sector systems use the well-known frequency division duplex (“FDD”) mechanisms to run multiple radios in a physical location. The use of FDD helps to reduce the interference of the radio transmitters. Two main usage methods for 3 sector applications are illustrated in FIG. 1. The first case 100 depicts an RF frequency usage pattern whereby each cluster comprises one base station site. Each base station site has three sectors in which each of the three sectors is assigned a unique RF channel. In the second case 102, an RF frequency usage pattern is depicted in which each cluster comprises one base station site and each base station site has three sectors with all sectors being assigned the same RF channel.

Interference in the first case 100 between the sectors using the same frequency is substantially less than in the second case. Therefore, the first case 100 configuration is currently preferred in most installations. The WiMAX Forum Mobility Profile document sets the following requirements:

For (1, 1, 3) reuse:

The DL user throughput, averaged over a cell area assuming a single user in target cell and Realistic Loaded neighbor cells under Fading and Mixed Mobility:

SHALL be higher than 0.2 Mbps/Hz times the RF channel size for release 1.

SHALL be higher than 0.5 Mbps/Hz times the RF channel size for release 2.

The UL user throughput, averaged over a cell area assuming a single user in target cell and Realistic Loaded neighbor cells under Fading and Mixed Mobility:

SHALL be higher than 0.1 Mbps/Hz times the RF channel size for release 1.

SHALL be higher than 0.25 Mbps/Hz times the RF channel size for release 2.

For (1, 3, 3) reuse:

The DL user throughput, averaged over a cell area assuming a single user in target cell and Realistic Loaded neighbor cells under Fading and Mixed Mobility:

SHALL be higher than 0.4 Mbps/Hz times the RF channel size for release 1.

SHALL be higher than 1.0 Mbps/Hz times the RF channel size for release 2.

The UL user throughput, averaged over a cell area assuming a single user in target cell and Realistic Loaded neighbor cells under Fading and Mixed Mobility:

SHALL be higher than 0.2 Mbps/Hz times the RF channel size for release 1.

SHALL be higher than 0.5 Mbps/Hz times the RF channel size for release 2.

In other words when all else is equal, the efficiency of the reuse-3 case 100 is about twice as efficient. The use of other techniques such a polarization does not generally help as much as in the cases of LOS systems.

Inter-subscriber station interference can result in loss of bandwidth, signal corruption, signal disruption and increased power requirements in wireless networks.

### BRIEF SUMMARY OF THE INVENTION

Certain embodiments of the invention enable the provision of enhanced service in wireless networks independent. Certain embodiments of the invention provide methods for wireless broadband scheduling that can comprise determining levels of potential interference between subscriber stations located in an area covered by a wireless base station.

Communication between the wireless base station and the subscriber stations can be scheduled to minimize interference between the subscriber stations. Scheduling may include ordering the subscriber stations based on the determined levels of potential interference for each station. Such scheduling may result in a list organized in ascending or descending order of potential interference or distance from the base station. Certain of the subscriber stations can be selected to communicate simultaneously based on the ordering. In certain of these embodiments, the ordering can be calculated to reduce mutual interference of the subscriber stations. Determining levels of potential interference can include measuring interference on each subscriber station. Determining may also include identifying relative proximity of each subscriber station to other subscriber stations.

### BRIEF DESCRIPTION OF THE DRAWINGS

Aspects and features of this application will become apparent to those ordinarily skilled in the art from the following detailed description of certain embodiments in conjunction with the accompanying drawings, wherein:

FIG. 1 depicts RF usage in a three sector wireless network;

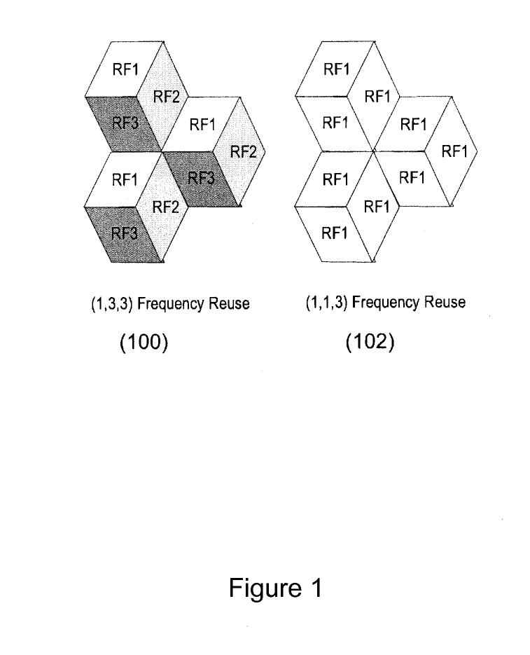

FIG. 2 depicts a simplified representation of a wireless network; and

FIG. 3 illustrates proximity considerations related to inter-subscriber station interference.

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the components referred to herein by way of illustration. Throughout this document an example embodying a 3 sector cell is used, but all of the discussions can easily be adopted for other configurations having any number of sectors.

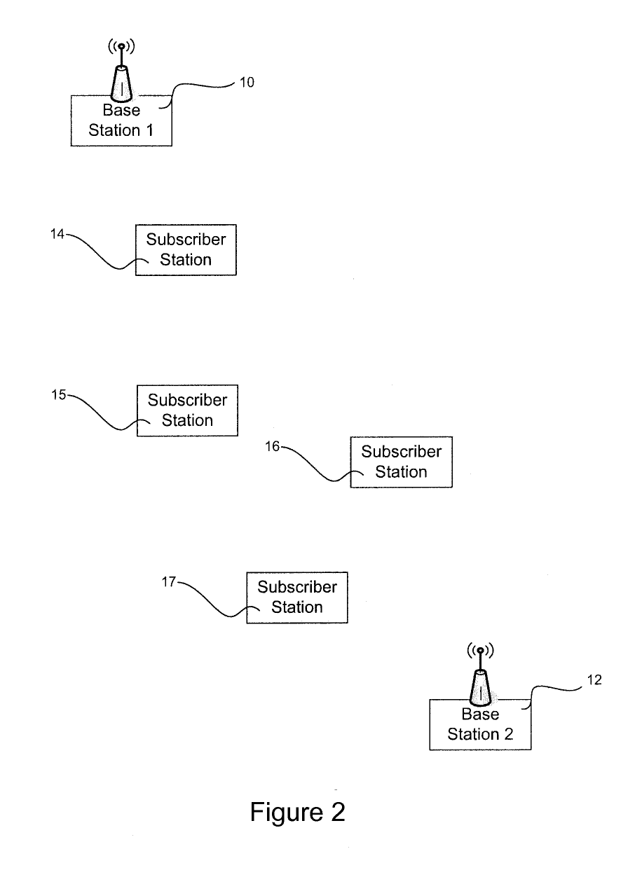

FIG. 2 illustrates a simplified wireless network comprising base stations 10 and 12 and plural subscriber stations 14, 15, 16 and 17. The subscriber stations 14, 15, 16 and 17 are located in various degrees of proximity and may communicate with one or both base stations 10 and 12. It will be appreciated that simultaneous transmissions by any two of subscriber stations 14, 15, 16 or 17 may result in inter-subscriber station interference. The degree of interference can depend on the relative signal strengths of interfering subscriber stations 14, 15, 16 or 17, the proximity of the interfering subscriber stations 14, 15, 16 or 17 and the timing of transmissions by the subscriber stations 14, 15, 16 and 17 and base stations 10 and 12.

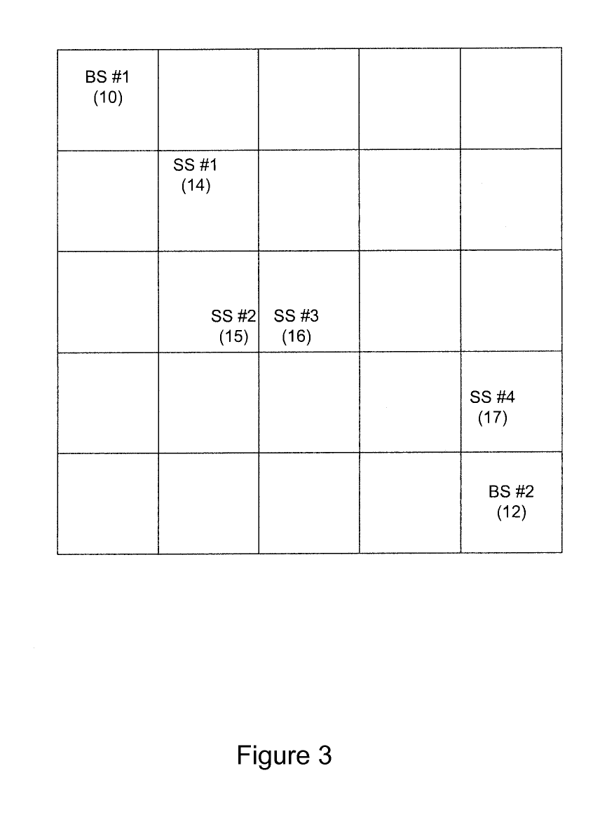

Certain embodiments of the invention employ time division duplex (“TDD”) techniques to reduce the effects of inter-subscriber station interference. TDD can be employed to control timing of transmissions by subscriber stations to minimize the potential for interference. TDD scheduling may also be used to satisfy bandwidth requests from one or more of subscriber stations 14, 15, 16 and 17. FIG. 3 illustrates in graphical form the relative locations of subscriber stations illustrated in the example of FIG. 2. The graph maps the apparent relative distances of the subscriber station. In certain embodiments, the distances assigned in FIG. 3 may be directly related to the physical locations of and actual distances separating base stations 10 and 12 and each subscriber stations 14, 15, 16 and 17. In some embodiments, the assigned distances may also reflect the effects of differences in power of transmitters in subscriber stations 14, 15, 16 and 17, sensitivity of receivers in base stations 10, 12 and subscriber stations 14, 15, 16 and 17 and other factors including geography and obstacles between base stations 10 and 12 and subscriber stations 14, 15, 16 and 17.

Interference can be expected to be at a maximum between proximately located subscriber stations. For example, in the example of FIG. 3, subscriber stations 15 and 16 are likely to exhibit greater potential for mutual interference than subscriber stations 14 and 17. Consequently, in certain embodiments of the invention, a TDD scheme is employed that schedules transmissions to and from subscriber stations 14, 15, 16 and 17 in a manner that minimizes potential interference. For example, subscriber stations 15 and 16 may be scheduled to transmit and receive at mutually exclusive times. Thus, in one example, subscriber station 15 and 17 may be scheduled to transmit at the same time while subscriber stations 14 and 16 are scheduled to transmit at a different time. This arrangement ensures that closest neighboring subscriber stations (here, 15 and 16) never transmit simultaneously.

The sequencing of transmissions may be calculated to prevent interference between subscriber stations 14, 15, 16 and 17 as detected by base stations 10 and 12. The base stations 10 and 12 typically assign distances to the subscriber stations 14, 15, 16 and 17 based on information obtained from a number of sources. Actual locations can be provided by one or more of the subscriber stations 14, 15, 16 and 17. In one example, the subscriber stations 14, 15, 16 and 17 may have access to GPS derived location information. In another example, the subscriber station may be located based on user provided information such as street address. In another example, the physical location of the subscriber stations 14, 15, 16 and 17 may be determined through triangulation.

In certain embodiments, the location of subscriber stations may be calculated based on received signal strengths measured at one or more base stations 10 and 12. Signal strength measurement may indicate and actual or apparent distance of subscriber stations 14, 15, 16 and 17 from a base station 10 or 12. Such information can be triangulated. It will be appreciated that other information may be used to determine physical location or to assign an apparent location, including known characteristics of the subscriber stations 14, 15, 16 and 17. In certain embodiments, interference may be measured at subscriber stations 14, 15, 16 and 17.

In certain embodiments, the base stations may generate a transmission schedule based on actual or apparent location of the subscriber stations 14, 15, 16 and 17. In certain embodiments, the schedule may be based on measured interference. In certain embodiments, calculations may be performed on a combination of measurements and a priori information (e.g. predetermined location, signal strength, etc.) to calculate potential interference between the subscriber stations 14, 15, 16 and 17. In many embodiments, subscriber stations may be listed or otherwise ordered according to factors that indicate a potential for interference. These factors may include actual or relative distance from base stations, actual or relative distance from other subscriber stations, transmission power and measured interference levels on one or more subscriber stations or base stations.

In certain embodiments, the transmission schedule may be adjusted to accommodate system priorities and subscriber preferences. For example, certain data transmissions may be assigned lower priority than, for example, voice transmissions. Thus, transmissions can be scheduled to reduce the effects of interference on audio communications to the detriment of a data transfer because error correction and retransmission of data is less likely to impact perceived quality of service in a network than noise or delays in audio-visual communications.

In certain embodiments, scheduling may be provided in a cooperative manner between base stations. Each base station may employ a scheduler that can communicate with schedulers in other base stations or with a centralized scheduler. In some embodiments, base stations may provide information to other schedulers including relative and actual location information regarding subscriber stations and interference measurements obtained from subscriber stations. This information may also include information concerning subscriber stations that are in communication with a different base station.

Additional Descriptions of Certain Aspects of the Invention

Certain embodiments of the invention provide methods for wireless broadband scheduling that can comprise determining levels of potential interference between subscriber stations located in an area covered by a wireless base station, receiving bandwidth requests for one or more of the subscriber stations, and scheduling communication between the wireless base station and the subscriber stations to minimize interference between the subscriber stations. In certain of these embodiments, the scheduling includes ordering the subscriber stations based on the determined levels of potential interference, and selecting certain of the subscriber stations to communicate simultaneously based on the ordering. In certain of these embodiments, the ordering is calculated to reduce mutual interference of the subscriber stations. In certain of these embodiments, the determining includes measuring interference on each subscriber station. In certain of these embodiments, the determining includes measuring interference on each subscriber station. In certain of these embodiments, the determining is based on predetermined information including location of the subscriber stations. In certain of these embodiments, the determining includes identifying relative proximity of each subscriber station to other subscriber stations.

In certain of these embodiments, one or more of the other subscriber stations communicate with a different base station. In certain of these embodiments, the determining includes identifying relative proximity of each subscriber station to subscriber stations that communicate with a different base station. In certain of these embodiments, the determination is performed by the wireless base station and a different base station. In certain of these embodiments, the scheduling is performed by the wireless base station and the different base station. In certain of these embodiments, the scheduling is performed by a central scheduler. In certain of these embodiments, the scheduling is at least partially performed by a central scheduler. In certain of these embodiments, the scheduling is at least partially performed by the wireless base station and the different base station.

Certain embodiments can comprise determining location of subscriber stations in an area covered by a wireless base station, ordering the subscriber stations based on the determined distances and scheduling transmission times of the subscriber stations based on the ordering. In certain of these embodiments, the ordering generates a listing of the subscriber stations arranged in ascending order of distance. In certain of these embodiments, the ordering generates a listing of the subscriber stations arranged in descending order of distance. In certain of these embodiments, the scheduling is calculated to reduce interference between subscriber stations. In certain of these embodiments, the determined distances include distances between subscriber stations. In certain of these embodiments, the determined distances include distances between subscriber stations and the wireless base station.

Although the present invention has been described with reference to specific exemplary embodiments, it will be evident to one of ordinary skill in the art that various modifications and changes may be made to these embodiments without departing from the broader spirit and scope of the invention. Accordingly, the specification and drawings are to be regarded in an illustrative rather than a restrictive sense.

What is claimed is:

1. A method of scheduling communications of subscriber stations within a geographic area, comprising:
determining location information associated with each subscriber station of a plurality of subscriber stations in a geographic area covered by one or more wireless base stations;
using the location information associated with each subscriber station of the plurality of subscriber stations in the geographic area to determine distance information between pairs of subscriber stations;
using the distance information between the pairs of subscriber stations to assist in estimating potential interference between the pairs of subscriber stations, were the pairs of subscriber stations to communicate simultaneously;
identifying a particular pair of subscriber stations with higher potential interference, were the particular pair of subscriber stations to communicate simultaneously; and
generating a communications schedule for each subscriber station of the plurality of subscriber stations in the geographic area, the communications schedule being based on the potential interference between the pairs of subscriber stations, the communications schedule reducing or eliminating simultaneous communication of the subscriber stations of the particular pair of subscriber stations with higher potential interference.

2. The method of claim 1, wherein the location information includes GPS coordinates.

3. The method of claim 1, wherein the location information includes a physical address.

4. The method of claim 1, wherein the location information includes signal strength information.

5. The method of claim 1, wherein each subscriber station of the particular pair of subscriber stations communicates with a different wireless base station of the one or more wireless base stations.

6. The method of claim 1, wherein the distance information between pairs of subscriber stations are relative distances.

7. The method of claim 1, wherein the communications schedule assists to allocate time slots for each subscriber station of the plurality of subscriber stations.

8. The method of claim 1, wherein the method is performed by one of the one or more wireless base stations.

9. The method of claim 1, wherein the method is performed by a centralized wireless base station.

10. The method of claim 1, wherein the generating the communications schedule for each subscriber station of the plurality of subscriber stations in the geographic area is further based on information type.

11. A first base station, comprising:
a processor operative to
determine location information associated with each subscriber station of a plurality of subscriber stations in a geographic area covered by one or more wireless base stations; and
use the location information associated with each subscriber station of the plurality of subscriber stations in the geographic area to determine distance information between pairs of subscriber stations;
a scheduler configured to
use the distance information between the pairs of subscriber stations to assist in estimating potential interference between the pairs of subscriber stations, were the pairs of subscriber stations to communicate simultaneously;
identify a particular pair of subscriber stations with higher potential interference, were the particular pair of subscriber stations to communicate simultaneously; and
generate a communications schedule for each subscriber station of the plurality of subscriber stations in the geographic area, the communications schedule being based on the potential interference between the pairs of subscriber stations, the communications schedule reducing or eliminating simultaneous communication of the subscriber stations of the particular pair of subscriber stations with higher potential interference.

12. The first base station of claim 11, wherein the location information includes GPS coordinates.

13. The first base station of claim 11, wherein the location information includes a physical address.

14. The first base station of claim 11, wherein the location information includes signal strength information.

15. The first base station of claim 11, wherein each subscriber station of the particular pair of subscriber stations communicates with a different wireless base station of the one or more wireless base stations.

16. The first base station of claim 11, wherein the distance information between pairs of subscriber stations are relative distances.

17. The first base station of claim 11, wherein the communications schedule assists to allocate time slots for each subscriber station of the plurality of subscriber stations.

18. The first base station of claim 11, wherein the first base station is one of the one of the one or more wireless base stations.

19. The first base station of claim 11, wherein the first base station is a centralized wireless base station.

20. The first base station of claim 11, wherein the scheduler generates the communications schedule for each subscriber station of the plurality of subscriber stations in the geographic area further based on information type.
